(19) United States
(12) Patent Application Publication
(10) Pub. No.: US 2006/0172677 A1
(43) Pub. Date: Aug. 3, 2006

(54) Apparatus for adjusting direction of wind in vehicle warming and cooling system

(76) Inventor: Jae Soo Ryu, ULSAN CITY (KR)

Correspondence Address: IPLA P.A., 3580 WILSHIRE BLVD., 17TH FLOOR, LOS ANGELES, CA, 90010, US

(21) Appl. No.: 10/547,446

(22) PCT Filed: Mar. 12, 2004
(86) PCT No.: PCT/KR04/00512

§ 371 Date: Aug. 26, 2005

(30) Foreign Application Priority Data
Mar. 25, 2003 (KR) 10-2003-0018372

(51) Int. Cl. B60H 1/34

(52) U.S. Cl. 454/152

(57) ABSTRACT

The present invention relates to an apparatus for adjusting a direction of wind in a cooling and warming system of a vehicle comprising a body in which a guide groove having a spring is formed at left and right sides, and a switch having an engaging hole at an upper center portion is formed, and an elongated hole is formed in a lower side of the engaging hole, and an adjusting plate in which an engaging protrusion is protruded from the upper and lower sides of the back surface, and a support protrusion into which an upper end of the spring is inserted is protruded from a lower surface of both sides, wherein the adjusting plate is engaged with a guide groove of the body.

### TECHNICAL FIELD

The present invention relates to an apparatus for adjusting a direction of wind in a vehicle warming and cooling system capable of maximizing a vehicle indoor cooling and warming efficiency in such a manner that a warming and cooling wind supplied from a vehicle warming and cooling system is supplied in a direction from a ventilation port to an upper surface of a dashboard, and a dashboard having a high temperature because it is exposed to sunlight in summer is cooled, and a dashboard having a low temperature in winter is cooled by a warming wind.

### BACKGROUND ART

Generally, cooling and warming wind supplied from a vehicle cooling and warming system is discharged through ventilation ports provided in a front center side, left and right sides and of a dashboard (instrument panel) and a plane before a front windshield.

The cooling and warming wind discharged through each ventilation port is circulated in the indoor of vehicle and maintains a certain temperature in the indoor of vehicle as a driver controls a wind direction adjusting lever, a temperature adjusting lever, etc.

However, in the operation that the cooling and warming system is operated for thereby maintaining a proper indoor temperature of vehicle, the following problems occur.

The sealed indoor of the vehicle in summer has higher temperature than the outdoor temperature. In particular, when the vehicle is exposed to the direct sunlight, the indoor temperature is increased to a very high temperature.

For example, the dashboard of the indoor of the vehicle has a very high temperature by the direct sunlight transmitted through the front windshield. The heat accumulated in the dashboard is discharged and increase the indoor temperature of the vehicle.

In a state that the indoor temperature of the vehicle is increased to a high temperature, the driver turns on an air conditioner for cooling the indoor of the vehicle. At this time, the heated dashboard is not easily cooled. When the vehicle is driven, the direct sunlight continuously heats the dashboard, so that the indoor temperature of the vehicle is not easily decreased.

Therefore, the driver operates a strong cooling wind of the air conditioner for a long time after the engine of the vehicle is started. Therefore, the driver exposed to a strong cooling wind for a long time may damage his health. In addition, the consumption of fuel is increased.

In winter, the heater is operated for warming the indoor of the vehicle. The indoor of the vehicle in winter has a low temperature due to an external low temperature. The indoor equipments are as cold as ice.

In a state that the indoor temperature of the vehicle is decreased, the driver turns on the heater for warming the indoor. In this case, the low temperature of the dashboard is not easily increased. Namely, the indoor temperature is transferred to the cold indoor dashboard during the running of the vehicle.

Therefore, the driver operates a strong wind of the heater for a long time after the heater is operated for warming the indoor of the vehicle. The driver exposed to a strong warming air for long time may damage his health. The consumption of fuel may be increased.

### DISCLOSURE OF INVENTION

### Technical Solution

Accordingly, it is an object of the present invention to provide an apparatus for adjusting a direction of wind of a vehicle cooling and warming system capable of overcoming the problems encountered in the conventional art.

It is another object of the present invention to provide an apparatus for adjusting a direction of wind of a vehicle cooling and warming system in which an adjusting plate is installed in one side of a ventilation port provided in a plane of a dashboard and appears and disappears, so that cooling and warming wind are supplied from a ventilation port to an upper surface of a dash board. Therefore, it is possible to cool a dashboard within a short time for thereby preventing the dashboard from being heated by the direct sunlight in summer, and in winter, it is possible to prevent an indoor temperature from being decreased in such a manner that warming air is directly supplied to a dashboard within a short time.

### DESCRIPTION OF DRAWINGS

The preferred embodiments of the present invention will be described with reference to the accompanying drawings.

FIG. 1 is a perspective view illustrating an apparatus for adjusting a direction of wind of a vehicle warming and cooling system according to a preferred embodiment of the present invention;

FIG. 2 is a cross sectional view illustrating a state of installation of an apparatus for adjusting a direction of wind of a vehicle warming and cooling system according to a preferred embodiment of the present invention;

FIG. 3 is a cross sectional view illustrating a state of operation of an apparatus for adjusting a direction of wind of a vehicle warming and cooling system according to a preferred embodiment of the present invention;

FIG. 4 is a perspective view illustrating an apparatus for adjusting a direction of wind of a vehicle warming and cooling system according to another embodiment of the present invention;

FIG. 5 is a perspective view illustrating a state of installation of an apparatus for adjusting a direction of wind of a vehicle warming and cooling system according to another embodiment of the present invention;

FIG. 6 is a perspective view illustrating a state of operation of an apparatus for adjusting a direction of wind of a vehicle warming and cooling system according to another embodiment of the present invention; and

FIG. 7 is a perspective view illustrating a state of installation of an apparatus for adjusting a direction of wind of a vehicle warming and cooling system according to further another embodiment of the present invention.

### BEST MODE

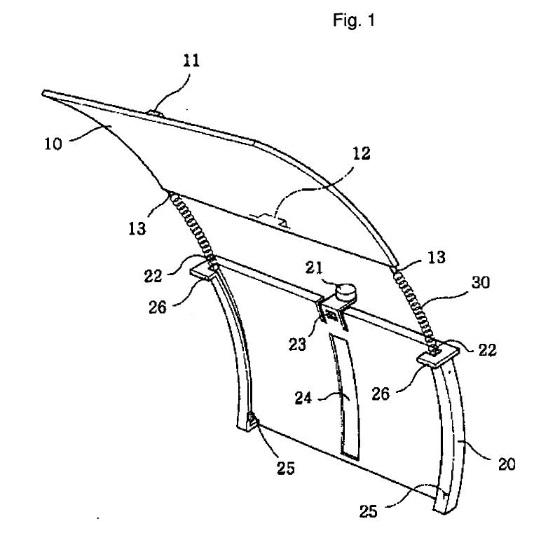

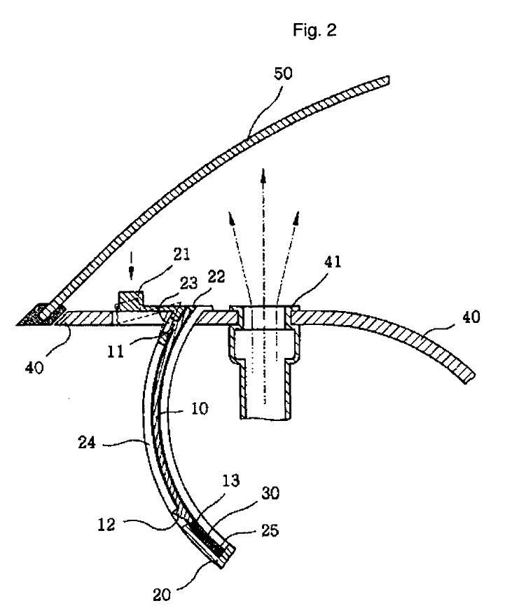

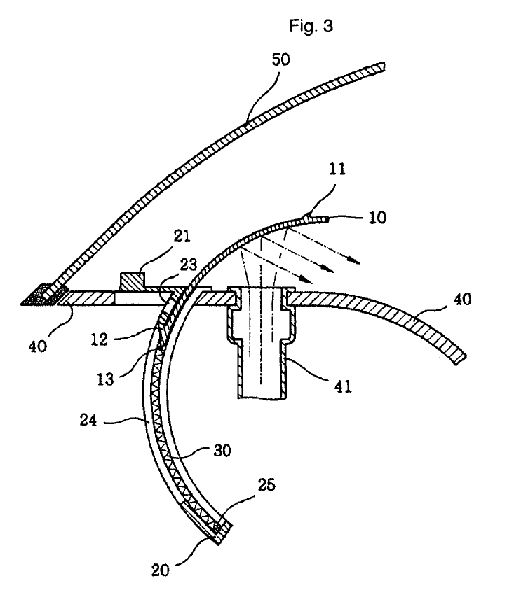

FIG. 1 is a perspective view illustrating an apparatus for adjusting a direction of wind of a vehicle warming and cooling system according to a preferred embodiment of the present invention, FIG. 2 is a cross sectional view illustrating a state of installation of an apparatus for adjusting a direction of wind of a vehicle warming and cooling system according to a preferred embodiment of the present invention, and FIG. 3 is a cross sectional view illustrating a state of operation of an apparatus for adjusting a direction of wind of a vehicle warming and cooling system according to a preferred embodiment of the present invention.

In the present invention, in a body 20, a guide groove 22 is formed at left and right sides wherein a spring 30 is inserted into the guide groove 22. A support protrusion 25 is protruded in a lower surface of the guide groove 22 wherein a lower end of the spring 30 is inserted thereinto. A switch 21 having an engaging hole 23 is formed at an upper center portion. An elongated hole 24 is formed in a lower side of the engaging hole 23.

In an adjusting plate 10, engaging protrusions 11 and 12 are formed at the upper and lower sides of a back surface. A support protrusion 13 into which an upper end of the spring 30 is inserted is protruded from a lower surface of both sides. The adjusting plate 10 is engaged to the guide groove 22 of the body 20.

The wind direction adjusting apparatus according to the present invention is engaged to one side of the ventilation port 41 provided in a plane of the dashboard 40.

Namely, the body 20 is inserted into an insertion hole (not shown) formed between a front wind shield 50 of a vehicle and a ventilation port 41, and a step part 26 contacts with an upper surface of the dashboard 40 for thereby achieving a fixing operation.

The construction, the method of use and operation of the present invention will be described.

When a cooling and warming system for warming in summer, namely, an air conditioner is operated, cooling air is discharged through the ventilation port 41 and is circulated in the indoor of vehicle for thereby maintaining a proper temperature.

Namely, the cooling air is flown vertically from the ventilation port 41 and is collide with the front wind shield 50 and then is circulated in the directions of the front and rear seats.

At this time, the indoor of the vehicle has a high temperature by high external temperature in summer. In particular, the dashboard 40 is exposed to the direct sunlight transmitted through the front wind shield 50 and is heated to a high temperature.

In the case that it is intended to cool the dashboard 40 of high temperature using cooling wind, the switch 21 installed in the upper center of the body 20 of the wind direction adjusting apparatus is pushed.

When the switch 21 is pushed, the engaging protrusion 11 protruded from the upper side of the back side of the adjusting plate 10 is escaped from the engaging hole 23 of the body 20.

When the engaging protrusion 11 is escaped from the engaging hole 23 of the body 20, the adjusting plate 10 is pushed in the upward direction of the dashboard 40 by an expansion force of the spring 30 elastically installed in the guide groove 22 of the body 20.

The adjusting plate 10 pushed by the spring 30 stops as the engaging protrusion 12 protruded from the lower side of the back side is engaged with an upper side of the elongated hole 24 of the body 20.

The adjusting plate 10 protruded from the upper side of the dash board 40 surrounds the upper side of the ventilation port 41, and the cooling wind discharged in the vertical direction collides with adjusting plate 10 and is discharged in the direction of the upper surface of the dashboard 40 for thereby cooling a high temperature dashboard 40.

The body 20 and the adjusting plate 10 according to the present invention may be constructed in a straight line shape in its lateral side. However, preferably, it is formed in a circular shape so that the cooling wind is effectively supplied to the dashboard 40.

After the heat of the dashboard 40 is decreased, the protruded adjusting plate 10 is pushed in the direction of the body 20, and the spring 30 is contracted. The adjusting plate 10 is pushed into the interior of the body 20, and the engaging protrusion 11 is inserted into the engaging hole 23 of the body 20.

When providing heat to the dashboard 40 in winder, the adjusting plate 10 is appeared and disappeared for thereby changing the direction of warming wind like the method for cooling heat of the dashboard 40 in simmer.

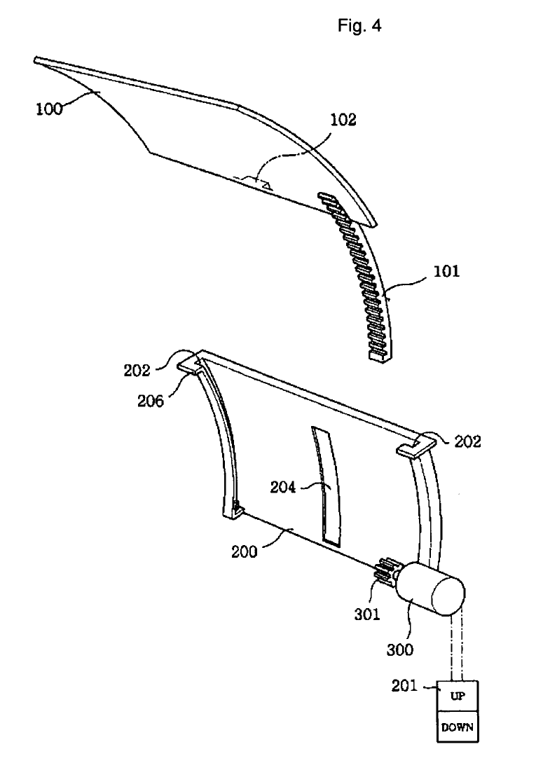

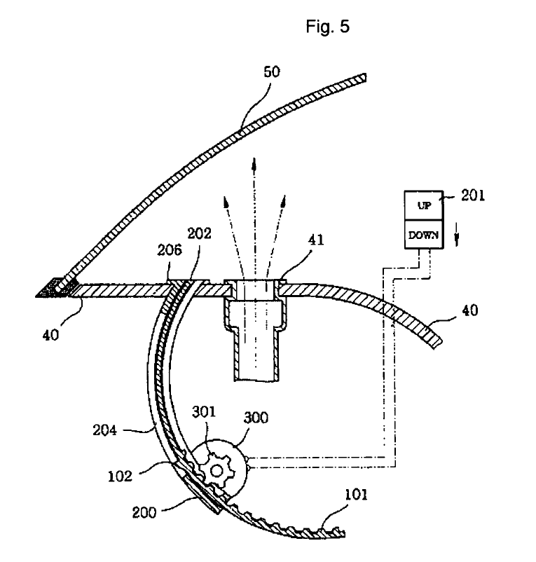

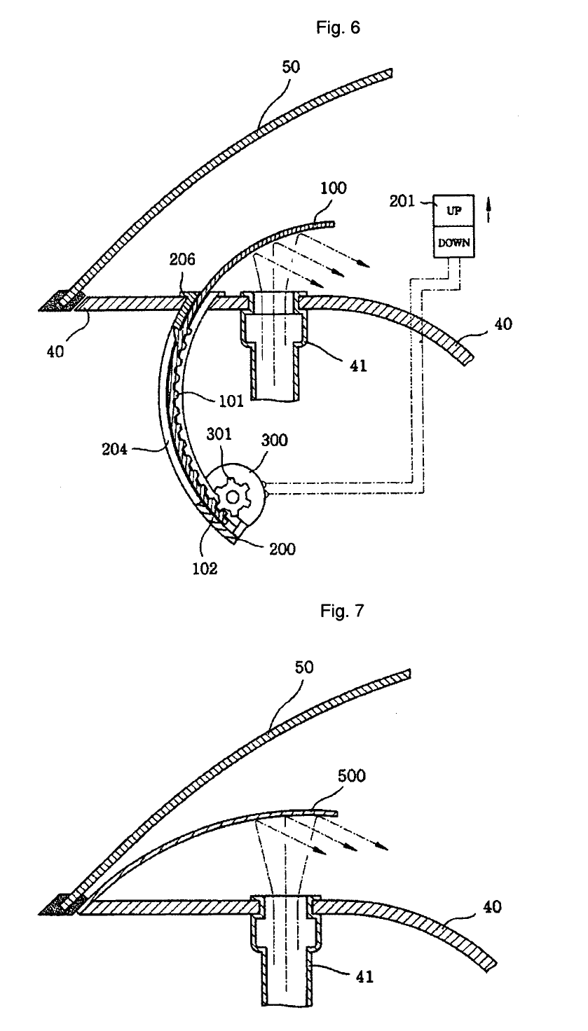

FIG. 4 is a perspective view illustrating an apparatus for adjusting a direction of wind of a vehicle warming and cooling system according to another embodiment of the present invention, FIG. 5 is a perspective view illustrating a state of installation of an apparatus for adjusting a direction of wind of a vehicle warming and cooling system according to another embodiment of the present invention, and FIG. 6 is a perspective view illustrating a state of operation of an apparatus for adjusting a direction of wind of a vehicle warming and cooling system according to another embodiment of the present invention.

In the construction of another embodiment of the present invention, in a body 200, a guide groove 202 is formed in left and right sides. An elongated hole 204 is formed at the center of the same. In addition, in an adjusting plate 100, an engaging protrusion 102 is protruded from a lower side of the back surface. A rack gear 101 is installed in one side of the lower surface and is engaged with a driving gear 301 of a motor 300.

The motor 300 is connected with a power of the vehicle through an electric cable and is normally or reversal rotated by the operation of the switch 201.

The wind direction adjusting apparatus according to the present invention is engaged to one side of the ventilation port 41 formed in the plane of the dashboard 40 like the earlier embodiment of the present invention.

Namely, the body 200 is inserted into the insertion hole formed between the front wind shield 50 of the vehicle and the ventilation port 41. The step part 206 is contacted with the upper surface of the dashboard 40 and is fixedly inserted thereinto. The construction, the method of use and operation of another embodiment of the present invention will be described.

In order to cool the dashboard 40 heated by the direct sunlight transmitted through the front wind shield using cooling wind or in order to warm the dashboard 40 cooled in winter, the switch 201 installed in the front side of the dashboard 40 is operated.

When the switch 201 is turned on, the driving gear 301 of the motor 300 is driven, and the rotational force of the driving gear 301 is transferred to the rack gear 101, and the adjusting plate 100 is upwardly pushed toward the upper side of the dashboard 40.

The adjusting plate 100 protruded from the upper side of the dashboard 40 surrounds the upper side of the ventilation port 41, and the cooling wind or warming wind discharged in the vertical direction collides with the adjusting plate 100 and is discharged in the direction of the upper surface of the dashboard 40, so that the dashboard 40 is cooled in summer or the dashboard 40 is heated in winter.

After the dashboard 40 is cooled or wormed, the switch 201 is turned off, and the driving gear 301 of the motor 300 is rotated in reverse direction, and the rotational force of the driving gear 301 is transferred to the rack gear 101, and the adjusting plate 100 is pushed into the interior of the body 200 along the guide groove 202.

FIG. 7 is a perspective view illustrating a state of installation of an apparatus for adjusting a direction of wind of a vehicle warming and cooling system according to further another embodiment of the present invention. As shown therein, a circular adjusting plate 500 is independently provided and is inserted into the end portion of the dashboard 40 contacting with the front wind shield 50 for thereby surrounding the ventilation port 41, so that it is possible to adjust the direction of cooling or warming wind discharged in the vertical direction.

### INDUSTRIAL APPLICABILITY

As described above, in the present invention, the apparatus is simply installed in one side of the ventilation port 41 provided in the plane of the dashboard 40, so that the cooling or warming wind discharged from the ventilation port 41 is moved in the direction of the upper surface of the dashboard 40 by adapting the adjusting plates 10, 100. Therefore, it is possible to cool the dashboard 40 for short time in summer for thereby minimizing the phenomenon that the dashboard 40 is heated by the direct sunlight, and it is possible to prevent the indoor temperature from being cooled by providing heat to the dashboard for short time in winter.

Therefore, in the present invention, it is possible to prevent the consumption of fuel due to over use of the warming and cooling system of the vehicle. The driver's health is protected for thereby achieving a desired purpose.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An apparatus for adjusting a direction of wind in a cooling and warming system of a vehicle, comprising:
a body 20 in which a guide groove 22 having a spring 30 is formed at left and right sides, and a switch 21 having an engaging hole 23 at an upper center portion is formed, and an elongated hole 24 is formed in a lower side of the engaging hole 23; and
an adjusting plate 10 in which an engaging protrusion 11, 12 is protruded from the upper and lower sides of the back surface, and a support protrusion 13 into which an upper end of the spring 30 is inserted is protruded from a lower surface of both sides, wherein the adjusting plate 10 is engaged with a guide groove 22 of the body 20,
wherein warming and cooling wind from the warming and cooling system of a vehicle are discharged in the direction of an upper surface of the dashboard 40 by an adjusting plate 10 that appears and disappears from the upper portion of the ventilation port 41.

2. An apparatus for adjusting a direction of wind in a cooling and warming system of a vehicle, comprising:
a body 200 in which a guide groove 202 is formed at left and right sides, and an elongated hole 204 is formed at a center;
an adjusting plate 100 in which an engaging protrusion 102 is protruded from a lower side of the back surface, and a rack gear 101 is formed in one side of the lower surface, and the body 200 is engaged to the guide groove 202; and
a motor 300 in which a driving gear 301 is engaged with the rack gear 101 wherein said motor 300 is rotated in a normal or reverse direction based on an operation of a switch 201,
wherein warming and cooling wind from the warming and cooling system of a vehicle are discharged in the direction of an upper surface of the dashboard 40 by an adjusting plate 10 that appears and disappears from the upper portion of the ventilation port 41.

3. An apparatus for adjusting a direction of wind in a cooling and warming system of a vehicle that is characterized in that warming and cooling wind from the warming and cooling system of a vehicle are discharged in the direction of an upper surface of the dashboard 40 by an adjusting plate 500 in such a manner that a circular adjusting plate 500 is independently provided and is inserted into an end portion of the dashboard 40 contacting with a front wind shield 50 for thereby surrounding an upper side of the ventilation port 41.
